(19) United States
(12) Patent Application Publication
(10) Pub. No.: US 2021/0389156 A1
(43) Pub. Date: Dec. 16, 2021

(54) MAP RENDERING METHOD AND APPARATUS, DEVICE, AND STORAGE MEDIUM

(71) Applicant: BEIJING BAIDU NETCOM SCIENCE AND TECHNOLOGY CO., LTD., Beijing (CN)

(72) Inventor: Hao LI, Beijing (CN)

(73) Assignee: BEIJING BAIDU NETCOM SCIENCE AND TECHNOLOGY CO., LTD., Beijing (CN)

(21) Appl. No.: 17/445,947

(22) Filed: Aug. 25, 2021

(30) Foreign Application Priority Data
Dec. 25, 2020 (CN) 202011566756.4

(51) Int. Cl. G01C 21/00; G01C 21/36; G01C 21/30

(52) U.S. Cl. CPC G01C 21/3811; G01C 21/3815; G01C 21/30; G01C 21/367

(57) ABSTRACT

Provided are a map rendering method and apparatus, a device, and a storage medium. The specific implementation scheme includes: acquiring reference road network data comprising a plurality of reference roads and trajectory point data comprising a plurality of trajectory points; determining, according to projection data of each of trajectory point elements in a trajectory point neighborhood set of each of the plurality of trajectory points onto at least one of the plurality of reference roads, a target road of the each of the plurality of trajectory points, respectively; and performing map rendering according to the target road of each of the plurality of trajectory points.

### CROSS-REFERENCE TO RELATED APPLICATION

This application claims priority to Chinese Patent Application No. 202011566756.4 filed Dec. 25, 2020, the disclosure of which is incorporated herein by reference in its entirety.

### TECHNICAL FIELD

The present application relates to the technical field of artificial intelligence, in particular, to the fields of electronic map and intelligent transportation, and specifically, to a map rendering method and apparatus, a device, and a storage medium.

### BACKGROUND

With the continuous development of Internet technology, map applications (APPs) are increasingly applied to people's daily life for users to query points of interest, perform route navigation and generate dynamic trajectories.

However, in the related art, in the process of using the map APP, there are defects such as poor rendering result accuracy, which degrades the use experience of users.

### SUMMARY

The present application provides a map rendering method and apparatus with higher rendering result accuracy, a device, and a storage medium.

According to an aspect of the present disclosure, a map rendering method is provided. The method includes the steps described below.

Reference road network data including a plurality of reference roads and trajectory point data including a plurality of trajectory points are acquired.

A target road of each of the plurality of trajectory points is determined respectively according to projection data of each of trajectory point elements in a trajectory point neighborhood set of the each of the plurality of trajectory points onto at least one of the plurality of reference roads.

Map rendering is performed according to the target road of each of the plurality of trajectory points.

According to another aspect of the present application, an electronic device is provided. The electronic device includes at least one processor; and a memory communicatively connected to the at least one processor.

The memory has instructions executable by the at least one processor stored thereon, where the instructions are executed by the at least one processor to cause the at least one processor to perform any one of the map rendering methods provided in the present application.

According to another aspect of the present application, a non-transitory computer-readable storage medium is provided. The non-transitory computer-readable storage medium has computer instructions stored thereon, where the computer instructions are configured to cause a computer to perform any one of the map rendering methods provided in the present application.

It is to be understood that the content described in this part is neither intended to identify key or important features of embodiments of the present application nor intended to limit the scope of the present application. Other features of the present application will be easily understood from the description provided hereinafter.

### BRIEF DESCRIPTION OF DRAWINGS

The drawings are intended to provide a better understanding of the present scheme and not to limit the present application. In the drawings:

FIG. 1 is a flowchart of a map rendering method according to the present application;

FIG. 2 is a flowchart of another map rendering method according to the present application;

FIG. 3 is a flowchart of another map rendering method according to the present application;

FIG. 4A is a flowchart of another map rendering method according to the present application;

FIG. 4B is a schematic diagram of reference road network data according to the present application;

FIG. 4C is a schematic diagram of trajectory point data according to the present application;

FIG. 4D is a schematic diagram of a binding relationship according to the present application;

FIG. 4E is a schematic diagram of a merged road according to the present application;

FIG. 4F is a schematic diagram of an updated merged road according to the present application;

FIG. 5 is a structural diagram of a map rendering apparatus according to the present application; and

FIG. 6 is a block diagram of an electronic device for implementing map rendering methods in embodiments of the present application.

### DETAILED DESCRIPTION

Exemplary embodiments of the present application, including details of the embodiments of the present application, are described hereinafter in conjunction with the drawings to facilitate understanding. The exemplary embodiments are merely exemplary. Therefore, it will be realized by those having ordinary skill in the art that various changes and modifications may be made to the embodiments described herein without departing from the scope and spirit of the present application. Similarly, description of well-known functions and constructions is omitted hereinafter for clarity and conciseness.

The map rendering methods and the map rendering apparatus provided by the embodiments of the present application are suitable for the case of performing electronic map rendering according to trajectory point data in the using of map applications, such as panoramic map rendering, dynamic trajectory tracking, or other application scenarios. The map rendering methods provided in the present application can be performed by a map rendering apparatus, and such an apparatus can be implemented by software and/or hardware and specifically configured in an electronic device.

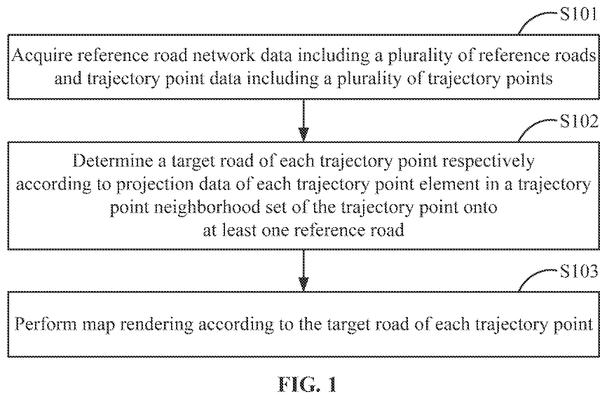

With reference to FIG. 1, a map rendering method is illustrated. The method includes the steps described below.

In step S101, reference road network data including a plurality of reference roads and trajectory point data including a plurality of trajectory points are acquired.

The reference road network data includes at least one of road identifiers of the plurality of reference roads, reference starting point identifiers of the plurality of reference roads, and reference ending point identifiers of the plurality of reference roads. In general, the reference road network data is known road network data. The reference road network data may be acquired from an existing geographic database or a map website, or may be pre-stored in a local electronic device for performing the map rendering method, other storage devices associated with the electronic device or a cloud and then acquired when map rendering needs to be performed.

The trajectory point data includes at least one of trajectory identifiers of the plurality of trajectory points, acquisition times of the plurality of trajectory points, acquisition directions of the plurality of trajectory points, a sequence of the plurality of trajectory points. For example, the trajectory point data may be data relate to trajectory points sequentially acquired by a panoramic vehicle according to set acquisition requirements, or may be trajectory points generated in the object tracking process. The tracking object may be at least one of a vehicle, a person, an animal, or the like.

The trajectory point data may be data corresponding to trajectory points acquired in real time, or may be data corresponding to pre-acquired trajectory points, which is stored in a local electronic device for performing the map rendering method, other devices associated with the local electronic device or a cloud and then acquired when map rendering needs to be performed.

In step S102, a target road of each trajectory point is determined respectively according to projection data of each trajectory point element in a trajectory point neighborhood set of the trajectory point onto at least one reference road.

In an optional embodiment, for each trajectory point in the trajectory point data, a trajectory point neighborhood set of the trajectory point may be acquired, and the target road of the trajectory point may be determined according to the projection of each trajectory point element in the trajectory point neighborhood set onto at least one reference road in the reference road network data.

It is to be understood that the target road of the trajectory point is determined in the same manner so that it is convenient to synchronously determine target roads of a plurality of trajectory points in an electronic device supporting multithreading, thereby improving the determination efficiency of the target roads.

Since the determination of the target road of each trajectory point needs to rely on a trajectory point neighborhood set including a plurality of trajectory point elements and, in addition, trajectory point neighborhood sets of different trajectory points may contain the same trajectory point elements, there is a case where a plurality of trajectory point elements are repeatedly projected, which causes a large amount of data computation and reduces the map rendering efficiency. In order to avoid the occurrence of the above case, in another optional embodiment, the target road may be determined only for some trajectory points by means of the trajectory point neighborhood set, so as to reduce the amount of data computation and improve the map rendering efficiency.

For example, each trajectory point may be projected onto at least one reference road around the trajectory point; if a trajectory point is projected onto one reference road, the one reference road is used as a target road of the trajectory point; and if a trajectory point is projected onto at least two reference roads, a target road of the trajectory point is determined according to projection data of each trajectory point element in a trajectory point neighborhood set of the trajectory point onto at least one of the at least two reference roads.

It is to be understood that when a trajectory point is projected onto only one reference road, it is not necessary to select the target road from the plurality of reference roads, and thus it is not necessary to determine the target road by referring to the projection of other trajectory point elements in the trajectory point neighborhood set of the trajectory point, thereby avoiding the waste of computing resources. Generally, in the process of acquiring trajectory points, the case of projection onto at least two reference roads occurs only at a trajectory point near a road intersection, while most of trajectory points are just projected onto only one reference road. Therefore, the target road of the trajectory point is directly determined in the case where the trajectory point is projected onto a single reference road, which can significantly reduce the amount of data computation in the process of determining target roads, thereby improving the map rendering efficiency.

In an embodiment, the trajectory point neighborhood set may be determined in the following manner: taking at least two other trajectory points whose space distance from a trajectory point is less than a set space distance threshold as adjacent trajectory points; and generating a trajectory point neighborhood set including the trajectory point and at least two adjacent trajectory points of the trajectory point. The set space distance threshold may be set by technicians according to requirements or empirical values or repeatedly determined or adjusted through a large number of tests.

When the trajectory point data includes a plurality of trajectory points acquired at different periods, for the determination through the space distance, the time correlation between trajectory points is ignored, which will affect the accuracy of the target road determination result to some extent. In order to avoid the occurrence of the above case, in an embodiment, the trajectory point neighborhood set may also be determined in the following manner: taking at least two other trajectory points whose acquisition time interval with a trajectory point is less than a set time threshold as adjacent trajectory points; and generating a trajectory point neighborhood set including the trajectory point and at least two adjacent trajectory points of the trajectory point. The set time threshold may be set by technicians according to requirements or empirical values or repeatedly determined or adjusted through a large number of tests.

Due to the case where the change directions of trajectory points near the road intersection are different, for example, at an L-shaped intersection, some of trajectory points are located in one of roads associated with the intersection while some of trajectory points are located in the other road associated with the intersection, when the adjacent trajectory points are determined only through the time interval, there will be a case where the determined adjacent trajectory points are inconsistent with the target road of the trajectory point, which affects the accuracy of the determination result of the target road of the trajectory point. In order to avoid the occurrence of the above case, in an embodiment, the trajectory point neighborhood set may also be determined in the following manner: selecting, according to acquisition times and change directions of the plurality of trajectory points in the trajectory point data, at least two adjacent trajectory points of a trajectory point from the plurality of trajectory points; and generating a trajectory point neighborhood set including the trajectory point and at least two adjacent trajectory points.

For example, at least two other trajectory points whose time interval with the acquisition time of a trajectory point is less than a set time threshold and whose change direction is the same as the change direction of the trajectory point may be selected as adjacent trajectory points; and a trajectory point neighborhood set including the trajectory point and at least two adjacent trajectory points of the trajectory point is generated. The set time threshold may be set by technicians according to requirements or empirical values or repeatedly determined or adjusted through a large number of tests.

It is to be understood that the acquisition period of each of the trajectory point elements in the trajectory point neighborhood set is constrained through the acquisition implementation, thereby avoiding the occurrence of poor accuracy of the determination result of the target road of the trajectory point due to the time correlation between the trajectory point elements being ignored; and the consistency of the projection road of each trajectory point element in the trajectory point neighborhood set is constrained through the change direction, thereby avoiding the occurrence of poor accuracy of the determination result of the target road of the trajectory point due to the difference between the projection roads of the adjacent trajectory points and the projection road of the trajectory point. Therefore, adjacent trajectory points are determined by means of the acquisition implementation and change direction, improving the accuracy of the determination result of the trajectory point neighborhood set and thus improving the accuracy of the determination result of the target road of the trajectory point.

The determination mechanism of the trajectory point neighborhood set and the determination mechanism of target roads corresponding to different trajectory points are described in detail in the foregoing content, and the determination of the target road of the trajectory point by using the trajectory point neighborhood set will be described in detail below.

In an optional embodiment, for each trajectory point, according to an accumulative projection distance of the trajectory point elements in the trajectory point neighborhood set of the trajectory point in each reference road, the target road of the trajectory point is determined from the plurality of reference roads.

In an embodiment, for each trajectory point, reference roads onto which trajectory point elements in a trajectory point neighborhood set of the trajectory point are projected are determined; and for each reference road, the sum of projection distances from the trajectory point elements in the trajectory point neighborhood set to the reference road is counted as the accumulative projection distance, and a reference road with a shorter accumulative projection distance is selected as the target road of the trajectory point.

It is to be understood that the target road is determined through the accumulative projection distance of the trajectory point elements in the trajectory point neighborhood set of the trajectory point on each reference road so that a reference road far away from the trajectory point may be identified as the target road, thereby improving the accuracy of the determination result of the target road.

However, since near the road intersection or when the trajectory point itself is abnormal, there is a case where one trajectory point corresponds to a plurality of reference roads for being projected onto, when most part of adjacent trajectory point elements in the trajectory point neighborhood set are projected onto a reference road A while a small part of the adjacent trajectory points are projected onto a reference road B, there may be a case where the accumulative projection distance on the reference road A is greater than the accumulative projection distance on the reference road B, and at this point, the determination result of the target road will be wrong.

In order to avoid the occurrence of the above case, in another optional embodiment, for each trajectory point, according to an accumulative number of projections of the trajectory point elements in the trajectory point neighborhood set of the trajectory point in each reference road, the target road of the trajectory point may be determined from the plurality of reference roads.

In an embodiment, for each trajectory point, reference roads onto which trajectory point elements in a trajectory point neighborhood set of the trajectory point are projected are determined; and for each reference road, the number of projections of the trajectory point elements in the trajectory point neighborhood set onto the reference road is counted, and a reference road with a larger accumulative number of projections is selected as the target road of the trajectory point.

It is to be understood that with the introduction of the accumulative number of projections, the target road is determined so that the case where the target road is wrongly determined through the accumulative projection distance near the road intersection or when the trajectory point itself is abnormal can be avoided, thereby improving the accuracy of the determination result of the target road.

However, when the location errors of most trajectory point elements in the trajectory point neighborhood set are large due to the poor condition of the acquisition environment or acquisition equipment of trajectory points, the case of the abnormal determination result of the target road may occur when only the accumulative projection distance or accumulative number of projections is considered. In order to improve the universality and accuracy of the determination manner of the target road, in another optional embodiment, for each trajectory point, according to the accumulative projection distance and the accumulative number of projections of the trajectory point elements in the trajectory point neighborhood set of the trajectory point in each reference road, the target road is determined from the plurality of reference roads.

In an embodiment, a reference road with a large accumulative number of projections (for example, the largest accumulative number of projections) and a short accumulative projection distance (for example, the shortest accumulative projection distance) may be determined as the target road. Alternatively, in an embodiment, for each reference road, a ratio of the accumulative projection distance to the accumulative number of projections is determined, and a reference road with a small ratio (for example, the smallest ratio) is determined as the target road.

In the process of selecting the target road, it is necessary to select a reference road with a smaller accumulative projection distance. Therefore, when a single trajectory point element has a larger projection distance to a reference road around it, the possibility of subsequently selecting the reference road as the target road is also low. In order to reduce the amount of data computation in the process of determining the target road, in an optional embodiment, before the target road is determined, reference roads onto which the projection is performed may also be preliminarily screened according to the projection distance of each trajectory point element to reference roads around.

For example, a projection distance of each trajectory point element onto reference roads around is determined; and a reference road with a projection distance greater than a set distance threshold is deleted. The set distance threshold may be set by technicians according to requirements or empirical values or repeatedly determined or adjusted through a large number of tests.

In step S103, map rendering is performed according to the target road of each of the plurality of trajectory points.

For example, each of target roads may be directly rendered in sequence in an electronic map, and the target roads may be merged and then the merged road is rendered in the electronic map. The rendered map may be applied to actual scenarios such as intelligent transportation or map navigation, which is not limited in the present application.

It is to be noted that the present application may be applied to the scenario of dynamic trajectory tracking, and accordingly, the determined target road is the tracking trajectory so that the trajectory tracking route is not affected by factors such as tracking equipment and tracking environment and has better accuracy and higher matching degree with the actual walking route of the tracking object. The present application may also be applied to the scenario of generating a panoramic road network, and accordingly, the data obtained after target roads are merged is the panoramic road network. Therefore, the roads matched with the trajectory point data may be merged, providing data support for the generation of the panoramic map, and meanwhile, when the map rendering is performed, the rendering efficiency is improved through the merging operation.

In the present application, with the introduction of projection data of each trajectory point element in the trajectory point neighborhood set of the trajectory point on at least one reference road, the target road of the trajectory point is determined, and thus in the process of determining the target road, the target road onto which the trajectory point is projected is determined with reference to the projection of other trajectory point elements in the trajectory point neighborhood set, which reduces the occurrence of poor accuracy of the determination result of the target road caused by isolated projection, thereby improving the accuracy of the determination result of the target road and thus improving the accuracy of the map rendering result.

When the trajectory point data is acquired, some trajectory points are lost due to the influence of the performance of trajectory point acquisition equipment or acquisition environment. In order to improve the comprehensiveness of the acquired trajectory point data and thus ensure the accuracy of the map rendering result, in an optional embodiment of the present application, after the step in which trajectory point data including a plurality of trajectory points is acquired is performed, and before the step in which a target road of each trajectory point is determined respectively according to projection data of each trajectory point element in a trajectory point neighborhood set of the trajectory point onto at least one reference road is performed, the following steps are additionally included: if acquisition times of two adjacent trajectory points are discontinuous, at least one lost trajectory point in the two adjacent trajectory points is predicted according to the two adjacent trajectory points; and the trajectory point data is updated according to the at least one lost trajectory point, so as to implement the prediction of the lost trajectory point.

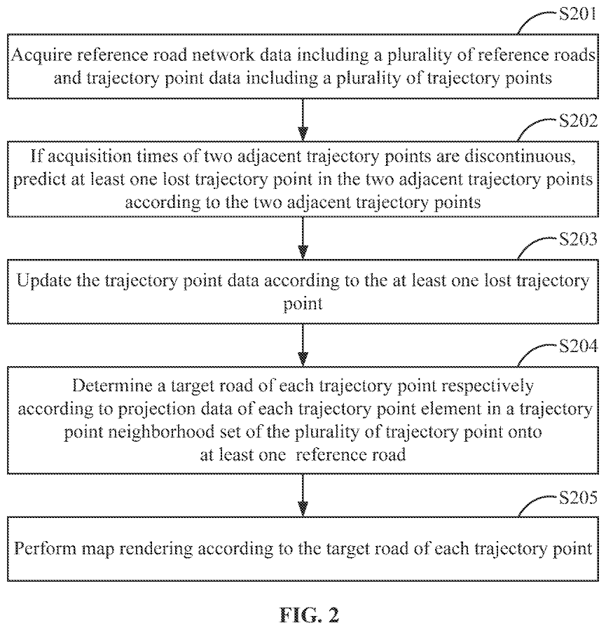

It is to be noted that for parts not described in detail in this optional embodiment, reference can be made to the description of the preceding embodiments. Further, with reference to FIG. 2, a map rendering method is illustrated. The method includes the steps described below.

In step S201, reference road network data including a plurality of reference roads and trajectory point data including a plurality of trajectory points are acquired.

In step S202, if acquisition times of two adjacent trajectory points are discontinuous, at least one lost trajectory point in two adjacent trajectory points is predicted according to the two adjacent trajectory points.

When the acquisition times of two adjacent trajectory points are discontinuous, there is a case where at least one trajectory point in the two adjacent trajectory points is lost, which will affect the accuracy of the determination result of the trajectory point neighborhood set and thus affect the accuracy of the map rendering result. In order to avoid the occurrence of the above case, the lost trajectory point is predicted for the acquired trajectory point data, and the trajectory point data is updated according to the prediction result, thereby improving the richness and comprehensiveness of the acquired trajectory point data and thus improving the accuracy of the determination result of the trajectory point neighborhood set.

For example, if acquisition times of two adjacent trajectory points are discontinuous, at least one lost trajectory point in two adjacent trajectory points is predicted according to the two adjacent trajectory points.

In a specific implementation, a reference rate may be determined according to a reference time interval between the two adjacent trajectory points and a reference distance interval between the two adjacent trajectory points; according to the reference time interval and a trajectory length of each of candidate road trajectories between the two adjacent trajectory points, a candidate rate of each of the candidate road trajectories is determined respectively; a target road trajectory is selected from the candidate road trajectories according to the candidate rate and the reference rate; and the at least one lost trajectory point is generated according to the target road trajectory.

In an embodiment, a difference between acquisition times of the two adjacent trajectory points is taken as a reference time interval; a difference between location information of the two adjacent trajectory points is taken as a reference distance interval; a reference rate is determined according to a ratio of the reference distance interval to the reference time interval; at least one connection route between the two adjacent trajectory points is determined by using a route planning algorithm and taken as candidate road trajectories; a trajectory length of each of the candidate road trajectories is determined; a candidate rate of each of the candidate road trajectories is determined according to a ratio of the trajectory length of each of the candidate road trajectories to the reference time interval; each of candidate rates is compared with the reference rate, and one candidate road trajectory with a small difference (for example, the smallest difference) from the reference rate as the target road trajectory; the number of lost trajectory points is determined according to the reference time interval between the two adjacent trajectory points and an acquisition frequency; and a corresponding number of lost trajectory points are selected from the target road trajectory. The selection manner may be at least one of arbitrary selection or uniform selection. The route planning algorithm may be implemented based on one algorithm or a combination of at least two algorithms in the related art, and the specific content or form of the algorithm is not limited in the present application.

In another specific implementation, a reference rate may be determined according to a reference time interval between the two adjacent trajectory points and a reference distance interval between the two adjacent trajectory points; according to the reference rate and a trajectory length of each of candidate road trajectories between the two adjacent trajectory points, a candidate time interval of each of the candidate road trajectories is determined respectively; a target road trajectory is selected from the candidate road trajectories according to the candidate time interval and the reference time interval; and the at least one lost trajectory point is generated according to the target road trajectory.

In an embodiment, a difference between acquisition times of the two adjacent trajectory points is taken as a reference time interval; a difference between location information of the two adjacent trajectory points is taken as a reference distance interval; a reference rate is determined according to a ratio of the reference distance interval to the reference time interval; at least one connection route between the two adjacent trajectory points is determined by using a route planning algorithm and taken as candidate road trajectories; a trajectory length of each of the candidate road trajectories is determined; a candidate time interval of each of the candidate road trajectories is determined according to a ratio of the trajectory length of each of the candidate road trajectories to the reference rate; each of candidate time intervals is compared with the reference time interval, and one candidate road trajectory with a small difference (for example, the smallest difference) from the reference time interval as the target road trajectory; the number of lost trajectory points is determined according to the reference time interval between the two adjacent trajectory points and an acquisition frequency; and a corresponding number of lost trajectory points are selected from the target road trajectory. The selection manner may be at least one of arbitrary selection or uniform selection. The route planning algorithm may be implemented based on one algorithm or a combination of at least two algorithms in the related art, and the specific content or form of the algorithm is not limited in the present application.

In another specific implementation, trajectory fitting may be performed according to a plurality of predicted trajectory point sets including two adjacent trajectory points to obtain a target road trajectory; and at least one fitting point is selected from the target road trajectory as the lost trajectory point.

In an embodiment, according to trajectory point acquisition times, trajectory points within a set time period where the two adjacent trajectory points are located are selected to construct a predicted trajectory point set; trajectory fitting is performed on trajectory point elements in the trajectory point set according to an acquisition sequence, and the trajectory fitting result is taken as a target road trajectory; the number of lost trajectory points is determined according to a reference time interval between the two adjacent trajectory points and the acquisition frequency; and a corresponding number of lost trajectory points are selected from the target road trajectory.

It is to be noted that the above-mentioned specific implementations are presented only as specific examples of lost trajectory point fitting to enrich the manner for predicting the lost trajectory point. The present application may also adopt another manner or a combination of at least two manners in the related art to predict the lost trajectory point, which is not limited in the embodiments of the present application.

In step S203, the trajectory point data is updated according to the at least one lost trajectory point.

At least one of data such as location information, acquisition time, acquisition direction, and trajectory point identifier of the lost trajectory point is added to the trajectory point data to update the trajectory point data, thereby improving the comprehensiveness of the trajectory point data. The location information is the location coordinates of the lost trajectory point in the target road trajectory. The acquisition time is the time calculated according to a location relationship between the two adjacent trajectory points and other lost trajectory points. The acquisition direction is the same as the acquisition direction of the two adjacent trajectory points. The trajectory point identifier may be a number which is numbered sequentially or another number which is inserted as required as long as the trajectory point identifiers of different trajectory points in the trajectory point data are different.

In step S204, a target road of each trajectory point is determined respectively according to projection data of each trajectory point element in a trajectory point neighborhood set of the trajectory point onto at least one reference road.

In step S205, map rendering is performed according to the target road of each trajectory point.

In the present application, after the trajectory point data including the plurality of trajectory points is acquired, and before the target road of each trajectory point is determined respectively according to the projection data of each trajectory point element in the trajectory point neighborhood set of the trajectory point onto at least one reference road, the following steps are additionally included: if acquisition times of two adjacent trajectory points are discontinuous, at least one lost trajectory point in the two adjacent trajectory points is predicted according to the two adjacent trajectory points; and the trajectory point data is updated according to the at least one lost trajectory point. In the preceding technical scheme, the lost trajectory point is predicted and the trajectory point data is updated, which improves the comprehensiveness of the trajectory point data, thereby improving the accuracy of the trajectory point neighborhood set of the trajectory point and thus improving the accuracy of the determination result of the target road.

In the above-mentioned technical schemes, when the map rendering is performed, there is a problem of low rendering efficiency because the electronic map is rendered for each target road. In view this, the present application provides an embodiment in which the map rendering operation is refined into the following steps: determining a merging sequence of target roads corresponding to the plurality of trajectory points according to an acquisition sequence of the plurality of trajectory points; merging the target roads according to the merging sequence to generate a merged road; and performing the map rendering according to the merged road, so as to improve the map rendering efficiency.

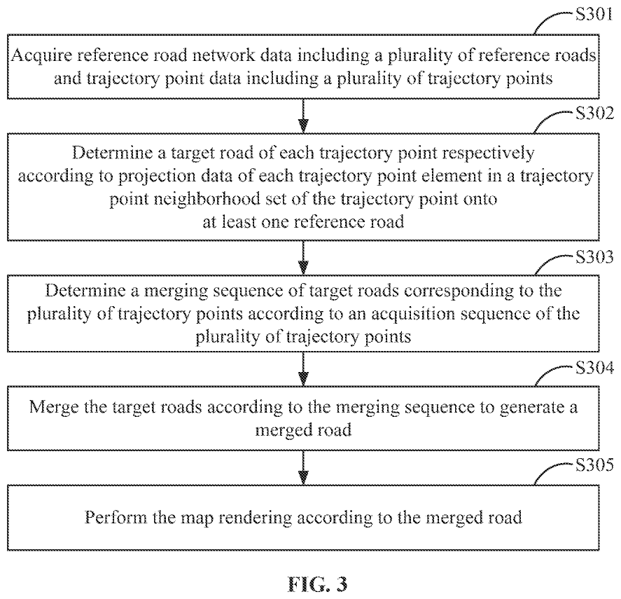

It is to be noted that for parts not described in detail in this optional embodiment, reference can be made to the description of the preceding embodiments. Further, with reference to FIG. 3, a map rendering method is illustrated. The method includes the steps described below.

In step S301, reference road network data including a plurality of reference roads and trajectory point data including a plurality of trajectory points are acquired.

In step S302, a target road of each trajectory point is determined respectively according to projection data of each trajectory point element in a trajectory point neighborhood set of the trajectory point onto at least one reference road.

In step S303, a merging sequence of target roads corresponding to the plurality of trajectory points is determined according to an acquisition sequence of the plurality of trajectory points.

For example, an acquisition sequence of the plurality of trajectory points may be determined according to an acquisition time of each trajectory point; and a merging sequence of target roads corresponding to the plurality of trajectory points is determined according to the acquisition sequence of the plurality of trajectory points.

In step S304, the target roads are merged according to the merging sequence to generate a merged road.

According to the merging sequence, the target roads are merged sequentially to generate a merged road.

It is to be noted that since different trajectory points may correspond to the same target road, the same target road may be merged only once or multiple times.

For example, if at least two continuous trajectory points correspond to the same target road, the target road is only merged with a target road corresponding to a subsequent trajectory point, and not repeatedly merged, thus avoiding unnecessary calculation and improving the road merging efficiency. If discontinuous trajectory points correspond to the same target road, the target roads of other trajectory points before the discontinuous trajectory points and the target roads of other trajectory points after the discontinuous trajectory points are merged at corresponding locations in sequence according to the acquisition sequence of the plurality of trajectory points.

In a specific implementation, when at least two continuous trajectory points correspond to the same target road, duplicate target roads are deleted, thereby achieving the de-duplication processing of the target road. For the target roads obtained after the de-duplication processing, according to the merging sequence, the ending point identifier of the previous target road in adjacent target roads and the starting point identifier of the latter target road in the adjacent target roads are sequentially merged to obtain a merged road.

In order to facilitate the search of target roads, a road query table and a starting-ending point query table may be generated in advance according to the road identifier, starting point identifier, and ending point identifier of each of the target roads in the reference road network data. In the process of merging target roads, for one current target road, the ending point identifier of the current target road is searched for according to the road identifier; the starting point identifier of the next target road is searched for according to the ending point identifier, and the current target road is merged with the ending point identifier of the next target road; and the next target road is taken as a new current target road and continues to be merged with the target roads until the merging of the target roads corresponding to all trajectory points in the trajectory point data is completed.

In step S305, the map rendering is performed according to the merged road.

It is to be understood that the electronic map is rendered once according to the merged road, instead of rendering the electronic map in turn for each of the target roads according to the merging sequence, thereby improving the rendering efficiency of the electronic map.

Meanwhile, in the application scenario of generating a panoramic road network, the generated merged road may be used as a panoramic road network, providing data support for the presentation of the panoramic map.

It is to be noted that since the plurality of trajectory points in the trajectory point data are not evenly distributed in all of the merged roads, there is a case where the merged roads in the rendered electronic map are longer than the roads in the actual situation. In order to further improve the accuracy of the merged road, in an optional embodiment, the merged road may also be intercepted according to location information of projection points of the trajectory points in the merged road.

Since the trajectory point data generally is data generated in one continuous acquisition process or a continuous tracking process, the trajectory points in the relative middle location in the trajectory point data have little influence on the accuracy of the merged road while the first trajectory point and the last trajectory point in the trajectory point data have relatively great influence on the accuracy of the merged road. Therefore, in a specific implementation, the step in which the map rendering is performed according to the merged road may be as follows: a starting point and an ending point of the merged road are determined respectively according to a projection point of a first trajectory point in the trajectory point data onto a target road of the first trajectory point and a projection point of a last trajectory point in the trajectory point data onto a target road of the last trajectory point; the merged road is intercepted according to the starting point and the ending point; and the map rendering is performed according to the intercepted merged road.

It is to be understood that the starting point and ending point of the merged road are constrained by the first trajectory point and the last trajectory point, which avoids the case in which the merged road is too long, thereby improving the accuracy of the determination result of the merged road and further improving the accuracy of the map rendering result.

In an embodiment, the projection point of the first trajectory point onto a corresponding target road is taken as the starting point of the merged road; the projection point of the last trajectory point onto a corresponding target road is taken as the ending point of the merged road; the road part before the starting point in the merged road and the road part after the ending point in the merged road are removed to update the merged road; and the map rendering is performed according to the updated merge road.

In a specific implementation, there is a case in which the merged road is a circular road, and thus if the preceding table query manner is adopted, the non-stopped circular merging is caused, and thus the abnormal road merging is caused. In order to avoid the occurrence of the above case, in the process of merging the roads, a merging status field may be set for each of the target roads to characterize the processing state of each of the target roads. The field values in the merging status field include merged, queried and default field. The merged indicates that the target road has participated in the generation of the merged road. The queried indicates that the target road does not participate in the generation of the merged road. The default field indicates that the target field has not been processed. Therefore, the merging situation of the target roads may be determined according to the field values of the merging status field until the traversal of all of the target roads is completed.

Since at least two discontinuous trajectory points correspond to the same target road, that is, when the roads are merged, the same target road may be merged at least twice under different conditions, a repeated merging field may be correspondingly set for each of the target roads to characterize the number of repeated merges or the number of merges to be repeated of each of the target roads. The field value of the repeated merging field is adjusted every time a target road is merged.

In an embodiment, when the repeated merging field is the number of repeated merges and when the number of repeated merges reaches a theoretical number of repeated merges, it indicates that the merging operation on the target road has been completed. The number of theoretical repeated merges is the statistical value of the target road after the de-duplication processing. When the repeated merging field is the number of merges to be repeated and when the number of merges to be repeated is 0, it indicates that the merging operation on the target road has been completed.

In the embodiments of the present application, the map rendering operation is refined into the following steps: determining a merging sequence of target roads corresponding to the plurality of trajectory points according to an acquisition sequence of the plurality of trajectory points; merging the target roads according to the merging sequence to generate a merged road; and performing the map rendering according to the merged road. In the present application, the electronic map is rendered once according to the merged road, which replaces the existing operation of rendering the electronic map in turn according to each of the target roads, thereby reducing the amount of data computation in the rendering process and improving the rendering efficiency. In addition, in the application scenario of generating a panoramic road network (where the merged road is the panoramic road network), the preceding technical scheme provides data support for the presentation of the panoramic map.

On the basis of the preceding technical scheme, the present application further provides a preferred embodiment of the map rendering method.

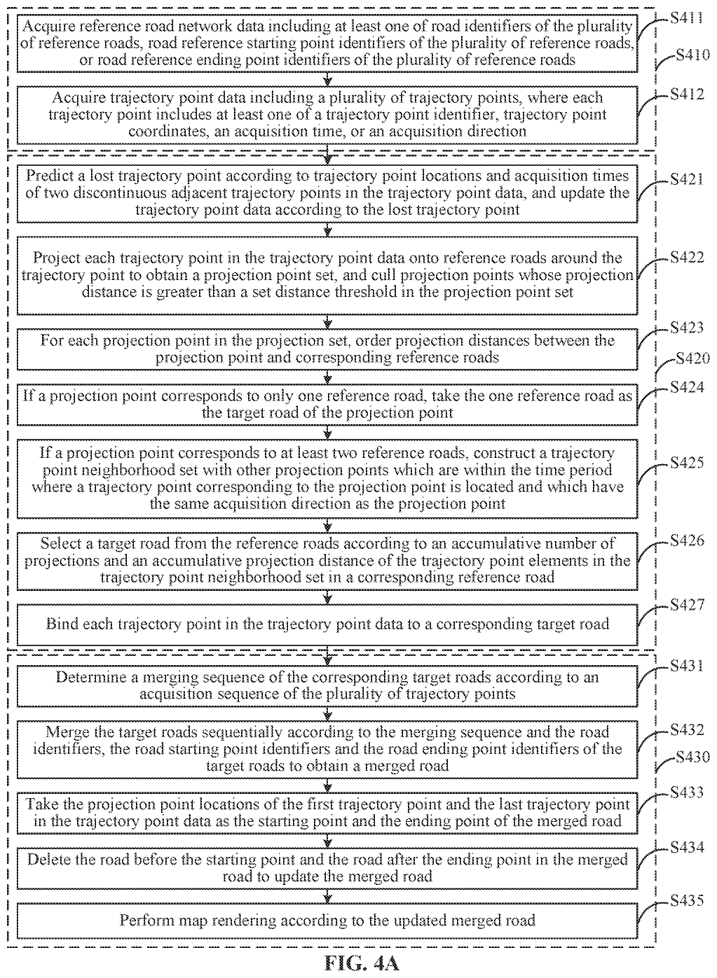

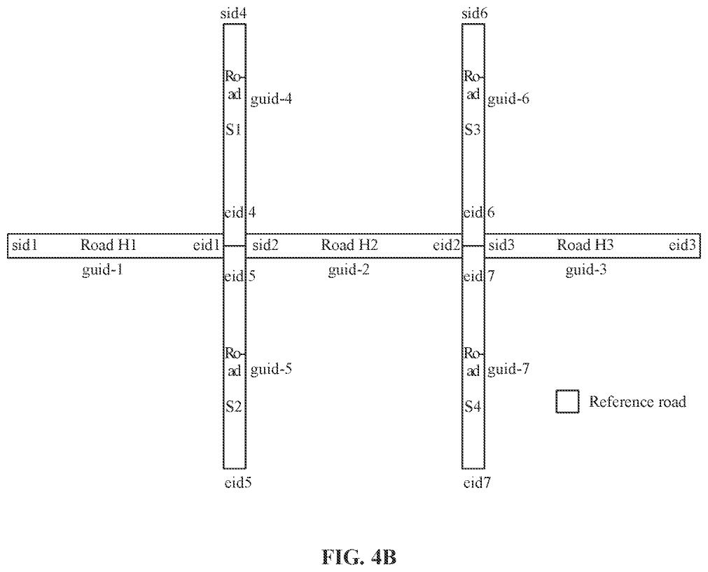

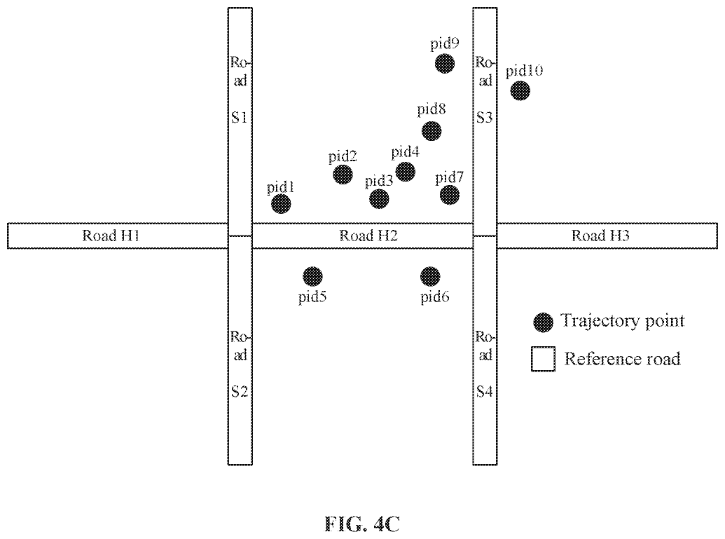

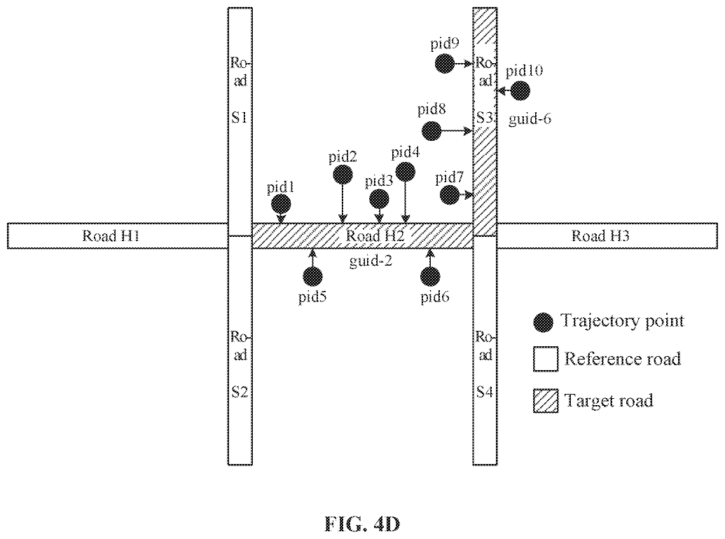

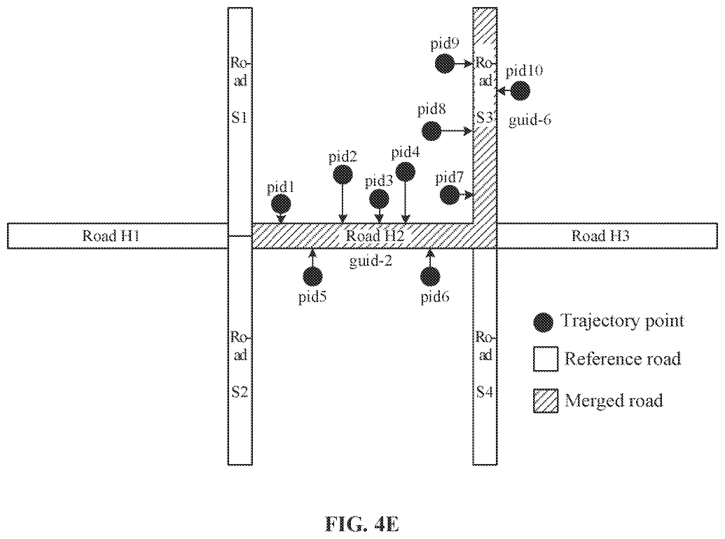

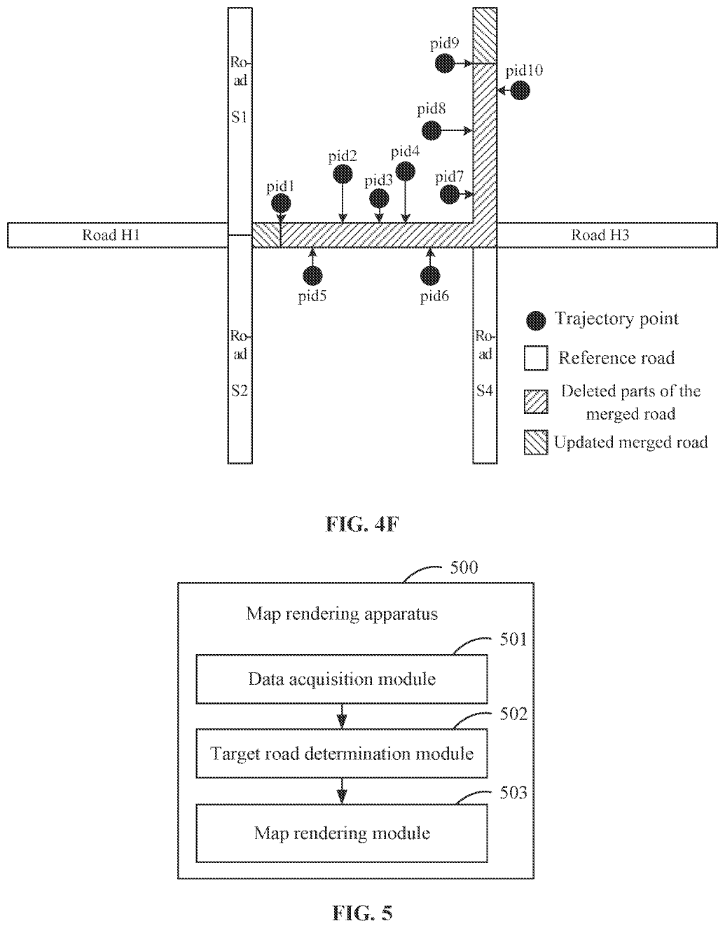

Further, with reference to FIG. 4A, a map rendering method is illustrated. The method includes the stages:

S410: a data acquisition stage;

S420: a trajectory point binding stage; and

S430: a map rendering stage.

For example, the data acquisition stage includes the steps described below.

In step S411, reference road network data is acquired, where the reference road network data includes at least one of road identifiers of the plurality of reference roads, road reference starting point identifiers of the plurality of reference roads, or road reference ending point identifiers of the plurality of reference roads.

With reference to FIG. 4B which shows a schematic diagram of reference road network data, in FIG. 4B, road identifiers are characterized by guid, road starting point identifiers are characterized by sid, and road ending point identifiers are characterized by eid. For example, the road identifier of a road H1 is guid-1, the road starting point identifier of the road H1 is sid1, and the road ending point of the road H1 is eid1. The road identifier of a road H2 is guid-2, the road starting point identifier of the road H2 is sid2, and the road ending point of the road H2 is eid2. The road identifier of a road H3 is guid-3, the road starting point identifier of the road H3 is sid3, and the road ending point of the road H3 is eid3. The road identifier of a road S1 is guid-4, the road starting point identifier of the road S1 is sid4, and the road ending point of the road S1 is eid4. The road identifier of a road S2 is guid-5, the road starting point identifier of the road S2 is sid5, and the road ending point of the road S2 is eid5. The road identifier of a road S3 is guid-6, the road starting point identifier of the road S3 is sid6, and the road ending point of the road S3 is eid6. The road identifier of a road S4 is guid-7, the road starting point identifier of the road S4 is sid7, and the road ending point of the road S4 is eid7. The road starting point identifiers of some roads at the road intersection correspond to the road ending point identifiers of some roads. It is to be noted that seven roads are illustrative as examples in FIG. 4B and are not to be construed as the limitation to the present application.

In step S412, trajectory point data including a plurality of trajectory points is acquired, where each trajectory point includes at least one of a trajectory point identifier, trajectory point coordinates, an acquisition time, or an acquisition direction.

With reference to FIG. 4C which shows a schematic diagram of trajectory point data, in FIG. 4C, trajectory point identifiers are characterized by pid. For example, pid1, pid2, . . . , and pid10 in FIG. 4C characterize trajectory point identifiers. It is to be noted that ten trajectory points are illustrative as examples in FIG. 4C and are not to be construed as the limitation to the present application.

For example, the trajectory point binding stage includes the steps described below.

In step S421, a lost trajectory point is predicted according to trajectory point locations and acquisition times of two discontinuous adjacent trajectory points in the trajectory point data, and the trajectory point data is updated according to the lost trajectory point.

For example, an average rate may be determined according to trajectory point locations and acquisition times of two discontinuous adjacent trajectory points in the trajectory point data; at least one candidate road trajectory between the two adjacent trajectory points is determined according to a path planning algorithm; according to the trajectory length of each of at least one candidate road trajectory and the acquisition time difference of two adjacent trajectory points, the candidate rate of each of at least one candidate road trajectory is determined, respectively; a candidate road trajectory corresponding to a candidate rate close to the average rate is selected as a target road trajectory; and lost trajectory points between two adjacent trajectory points are determined from the target road trajectory, and the trajectory point data is updated according to the lost trajectory points.

In step S422, each trajectory point in the trajectory point data is projected onto reference roads around the trajectory point to obtain a projection point set, and projection points whose projection distance is greater than a set distance threshold in the projection point set are culled.

In step S423, for each projection point in the projection set, projection distances between the projection point and corresponding reference roads are ordered.

In step S424, if a projection point corresponds to only one reference road, the one reference road is taken as the target road of the projection point.

In step S425, if a projection point corresponds to at least two reference roads, other projection points which are within the time period where a trajectory point corresponding to the projection point is located and which have the same acquisition direction as the projection point construct a trajectory point neighborhood set.

In step S426, a target road is selected from the reference roads according to an accumulative number of projections and an accumulative projection distance of the trajectory point elements in the trajectory point neighborhood set in a corresponding reference road.

In step S427, each trajectory point in the trajectory point data is bound to a corresponding target road.

With reference to FIG. 4D which shows a schematic diagram of a binding relationship, in FIG. 4D, the arrow represents the projection and also represents the binding relationship between a trajectory point and a target road; the location which the arrow points to is the projection location of the trajectory point; and the roads in the shaded part are the target roads, and the roads in the non-shaded part are the reference roads.

Of course, the binding relationship between the trajectory point and the target road may also be reflected by associating the trajectory point identifier and the road identifier and storing such an association. For example, (pid1, guid-2) reflects the binding relationship between the trajectory point pid1 and the road H2.

For example, the map rendering stage includes the steps described below.

In step S431, a merging sequence of the corresponding target roads is determined according to an acquisition sequence of the plurality of trajectory points.

In step S432, the target roads are sequentially merged according to the merging sequence and the road identifiers, the road starting point identifiers and the road ending point identifiers of the target roads to obtain a merged road.

With reference to FIG. 4E which shows a schematic diagram of a merged road, in FIG. 4E, the roads in the shaded part is the merged road.

In step S433, the projection point locations of the first trajectory point and the last trajectory point in the trajectory point data are taken as the starting point and the ending point of the merged road.

In step S434, the road before the starting point and the road after the ending point in the merged road are deleted to update the merged road.

With reference to FIG. 4F which shows a schematic diagram of an updated merged road, in FIG. 4F, some roads deleted from the merged road before updating are displayed distinguishingly.

In step S435, the map rendering is performed according to the updated merged road.

The present application is applicable to application scenarios of dynamic trajectory tracking or panoramic road network rendering. In different application scenarios, at least one step may be selected for execution or replacement as required. For example, in the process of dynamic trajectory tracking, after step S427, each target road may be directly rendered in the map, which improves the accuracy of the determined trajectory tracking result. For example, in the application scenario of panoramic road network rendering, the finally determined merged road is the panoramic road network, and the map rendering is performed based on the panoramic road network, which provides data support for the presentation of the panoramic map and improves the rendering efficiency.

As the implementation of the preceding map rendering methods, the present application further provides an embodiment of a virtual apparatus for implementing the map rendering methods.

Further, with reference to FIG. 5, a map rendering apparatus 500 includes a data acquisition module 501, a target road determination module 502, and a map rendering module 503.

The data acquisition module 501 is configured to acquire reference road network data including a plurality of reference roads and trajectory point data including a plurality of trajectory points.

The target road determination module 502 is configured to determine, according to projection data of each trajectory point element in a trajectory point neighborhood set of each trajectory point onto at least one reference road, a target road of the trajectory point, respectively.

The map rendering module 503 is configured to perform map rendering according to the target road of each trajectory point.

In the present application, with the introduction of projection data of each trajectory point element in the trajectory point neighborhood set of each trajectory point onto at least one reference road, the target road of each trajectory point is determined, and thus in the process of determining the target road, the target road onto which a trajectory point is projected is determined with reference to the projection of other trajectory point elements in the trajectory point neighborhood set, which reduces the occurrence of poor accuracy of the determination result of the target road caused by isolated projection, thereby improving the accuracy of the determination result of the target road and thus improving the accuracy of the map rendering result.

In an optional embodiment, the target road determination module 502 includes a trajectory point projection unit, a first target road determination unit, and a second target road determination unit.

The trajectory point projection unit is configured to project each trajectory point onto at least one reference road around the trajectory point.

The first target road determination unit is configured to, if a trajectory point is projected onto one reference road, use the one reference road as a target road of the trajectory point.

The second target road determination unit is configured to, if a trajectory point is projected onto at least two reference roads, determine, according to projection data of each trajectory point element in a trajectory point neighborhood set of the trajectory point onto at least one of the at least two reference roads, a target road of the trajectory point.

In an optional embodiment, the target road determination module 502 includes a target road distance determination unit and/or a target road number determination unit.

The target road distance determination unit is configured to, for each trajectory point, determine, according to an accumulative projection distance of the trajectory point elements in the trajectory point neighborhood set of the trajectory point in each reference road, the target road of the trajectory point from the plurality of reference roads.

The target road number determination unit is configured to, for each trajectory point, determine, according to an accumulative number of projections of the trajectory point elements in the trajectory point neighborhood set of the trajectory point in each reference road, the target road of the trajectory point from the plurality of reference roads.

In an optional embodiment, the apparatus further includes a trajectory point neighborhood set determination module, which is configured to determine the trajectory point neighborhood set of each trajectory point.

The trajectory point neighborhood set determination module includes an adjacent trajectory point selection unit and a trajectory point neighborhood set generation unit.

The adjacent trajectory point selection unit is configured to select, according to an acquisition time and a change direction of each trajectory point in the trajectory point data, at least two adjacent trajectory points of the trajectory point from the plurality of trajectory points.

The trajectory point neighborhood set generation unit is configured to generate the trajectory point neighborhood set comprising the trajectory point and the at least two adjacent trajectory points.

In an optional embodiment, the apparatus further includes a lost trajectory point prediction module and a trajectory point data update module.

The lost trajectory point prediction module is configured to, after the trajectory point data comprising the plurality of trajectory points is acquired and before the target road of each trajectory point is determined according to the projection data of each trajectory point element in the trajectory point neighborhood set of each trajectory point onto at least one reference road, respectively, if acquisition times of two adjacent trajectory points are discontinuous, predict at least one lost trajectory point in the two adjacent trajectory points according to the two adjacent trajectory points.

The trajectory point data update module is configured to update the trajectory point data according to the at least one lost trajectory point.

In an optional embodiment, the lost trajectory point prediction module includes a reference rate determination unit, a candidate rate determination unit, a target road trajectory selection unit, and a lost trajectory point generation unit.

The reference rate determination unit is configured to determine a reference rate according to a reference time interval between the two adjacent trajectory points and a reference distance interval between the two adjacent trajectory points.

The candidate rate determination unit is configured to determine, according to the reference time interval and a trajectory length of each of candidate road trajectories between the two adjacent trajectory points, a candidate rate of the each of the candidate road trajectories, respectively.

The target road trajectory selection unit is configured to select a target road trajectory from the candidate road trajectories according to the candidate rate and the reference rate.

The lost trajectory point generation unit is configured to generate the at least one lost trajectory point according to the target road trajectory.

In an optional embodiment, the lost trajectory point prediction module includes a reference rate determination unit, a candidate time interval determination unit, a target road trajectory selection unit, and a lost trajectory point generation unit.

The reference rate determination unit is configured to determine a reference rate according to a reference time interval between the two adjacent trajectory points and a reference distance interval between the two adjacent trajectory points.

The candidate time interval determination unit is configured to determine, according to the reference rate and a trajectory length of each of candidate road trajectories between the two adjacent trajectory points, a candidate time interval of the each of the candidate road trajectories, respectively.

The target road trajectory selection unit is configured to select a target road trajectory from the candidate road trajectories according to the candidate time interval and the reference time interval.

The lost trajectory point generation unit is configured to generate the at least one lost trajectory point according to the target road trajectory.

In an optional embodiment, the map rendering module 503 includes a merging sequence determination unit, a merged road generation unit, and a map rendering unit.

The merging sequence determination unit is configured to determine a merging sequence of target roads corresponding to the plurality of trajectory points according to an acquisition sequence of the plurality of trajectory points.

The merged road generation unit is configured to merge the target roads according to the merging sequence to generate a merged road.

The map rendering unit is configured to perform the map rendering according to the merged road.

In an optional embodiment, the map rendering unit includes a starting-ending point determination sub-unit, a merged road interception sub-unit, and a map rendering sub-unit.

The starting-ending point determination sub-unit is configured to determine, according to a projection point of a first trajectory point in the trajectory point data onto a target road of the first trajectory point and a projection point of a last trajectory point in the trajectory point data onto a target road of the last trajectory point, a starting point and an ending point of the merged road, respectively.

The merged road interception sub-unit is configured to intercept the merged road according to the starting point and the ending point.

The map rendering sub-unit is configured to perform the map rendering according to the intercepted merged road.

The preceding map rendering apparatus may execute the map rendering method provided by any of the embodiments of the present application, and has functional modules and beneficial effects corresponding to the execution of the map rendering method.

According to an embodiment of the present application, the present application further provides an electronic device, a readable storage medium, and a computer program product.

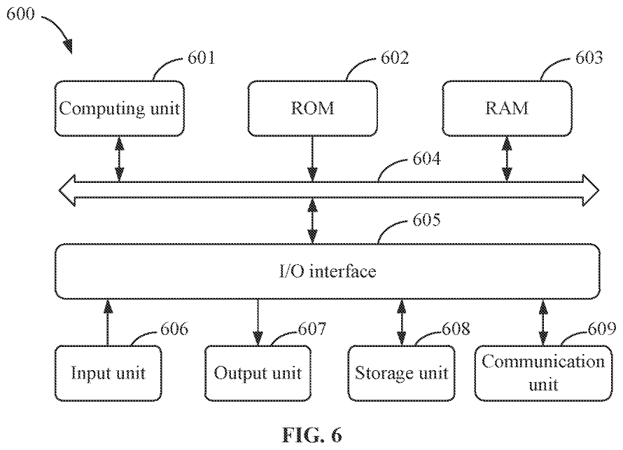

FIG. 6 is an illustrative block diagram of an exemplary electronic device 600 that may be used for implementing the embodiments of the present application. The electronic device is intended to represent various forms of digital computer, for example, a laptop computer, a desktop computer, a worktable, a personal digital assistant, a server, a blade server, a mainframe computer or another applicable computer. The electronic device may also represent various forms of mobile device, for example, a personal digital assistant, a cellphone, a smartphone, a wearable device or another similar computing device. Herein the shown components, the connections and relationships between these components, and the functions of these components are illustrative only and are not intended to limit the implementation of the present application as described and/or claimed herein.

As shown in FIG. 6, the device 600 includes a computing unit 601. The computing unit 601 may execute various types of appropriate actions and processing according to a computer program stored in a read-only memory (ROM) 602 or a computer program loaded from a storage unit 608 to a random access memory (RAM) 603. Various programs and data required for operations of the device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605. The multiple components include an input unit 606 such as a keyboard and a mouse, an output unit 607 such as various types of displays and speakers, the storage unit 608 such as a magnetic disk and an optical disk, and a communication unit 609 such as a network card, a modem and a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Some examples of the computing unit 601 include, but are not limited to, central processing units (CPUs), graphics processing units (GPUs), various special-purpose artificial intelligence (AI) computing chips, various computing units running machine learning models and algorithms, digital signal processors (DSPs), and any appropriate processors, controllers and microcontrollers. The computing unit 601 performs various methods and processing described above, such as the map rendering method. For example, in some embodiments, the map rendering method may be implemented as a computer software program tangibly contained in a machine-readable medium such as the storage unit 608. In some embodiments, part or all of a computer program may be loaded and/or installed on the device 600 via the ROM 602 and/or the communication unit 609. When the computer program is loaded to the RAM 603 and executed by the computing unit 601, one or more steps of the preceding map rendering method may be performed. Alternatively, in other embodiments, the computing unit 601 may be configured, in any other appropriate manner (for example, by means of firmware), to perform the map rendering method.

Herein various implementations of the systems and techniques described above may be implemented in digital electronic circuitry, integrated circuitry, field-programmable gate arrays (FPGAs), application-specific integrated circuits (ASICs), application-specific standard products (ASSPs), systems on a chip (SoCs), complex programmable logic devices (CPLDs), computer hardware, firmware, software and/or combinations thereof. The various implementations may include implementations in one or more computer programs. The one or more computer programs are executable and/or interpretable on a programmable system including at least one programmable processor. The programmable processor may be a dedicated or general-purpose programmable processor which can receive data and instructions from a memory system, at least one input device and at least one output device and transmit data and instructions to the memory system, the at least one input device and the at least one output device.

Program codes for implementing the methods of the present application may be written in any combination of one or more programming languages. These program codes may be provided for a processor or controller of a general-purpose computer, a special-purpose computer or another programmable data processing device such that the program codes, when executed by the processor or controller, cause functions/operations specified in the flowcharts and/or block diagrams to be implemented. The program codes may be executed in whole on a machine, executed in part on a machine, executed, as a stand-alone software package, in part on a machine and in part on a remote machine, or executed in whole on a remote machine or a server.

In the context of the present application, the machine-readable medium may be a tangible medium that may include or store a program that is used by or used in conjunction with a system, apparatus or device that executes instructions. The machine-readable medium may be a machine-readable signal medium or a machine-readable storage medium. The machine-readable medium may include, but are not limited to, electronic, magnetic, optical, electromagnetic, infrared or semiconductor systems, apparatuses or devices or any suitable combinations thereof. More specific examples of the machine-readable storage medium may include an electrical connection based on one or more wires, a portable computer disk, a hard disk, an RAM, an ROM, an erasable programmable read-only memory (EPROM), a flash memory, an optical fiber, a portable compact disk read-only memory (CD-ROM), an optical memory device, a magnetic memory device or any suitable combination thereof.

In order to provide the interaction with a user, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user may provide input to the computer. Other types of devices may also be used for providing the interaction with the user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system (for example, a data server) including a back-end component, a computing system (for example, an application server) including a middleware component, a computing system (for example, a user computer having a graphical user interface or a web browser through which a user may interact with implementations of the systems and techniques described herein) including a front-end component or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a traditional physical host and a traditional virtual private server (VPS) service. The server may also be a server of a distributed system or a server combined with blockchain.

Artificial intelligence is a discipline that studies making computers simulate some thinking processes and intelligent behaviors (such as learning, reasoning, thinking and planning) of humans, and has both hardware-level technologies and software-level technologies. The artificial intelligence hardware technologies generally include technologies such as sensors, special artificial intelligence chips, cloud computing, distributed storage, and big data processing. The artificial intelligence software technologies mainly include computer vision technology, speech recognition technology, natural language processing technology, machine learning/deep learning technology, big data processing technology, knowledge map technology, and the like.

The cloud computing refers to a technical system that accesses flexible and scalable shared physical or virtual resource pools through the network, in which resources can include servers, operating systems, networks, software, applications, and storage devices, and deploys and manages resources on demand and in a self-service manner. Cloud computing technology can provide efficient and powerful data processing capabilities for artificial intelligence, blockchain, and other technology applications and model training.

It is to be understood that various forms of the preceding flows may be used, with steps reordered, added or deleted. For example, the steps described in the present application may be executed in parallel, in sequence or in a different order as long as the desired results of the technical schemes disclosed in the present application are achieved. The execution sequence of these steps is not limited herein.

The scope of the present application is not limited to the preceding specific implementations. It is to be understood by those skilled in the art that various modifications, combinations, sub-combinations and substitutions may be made depending on design requirements and other factors. Any modification, equivalent substitution, improvement and the like made within the spirit and principle of the present application should be within the scope of the present application.

What is claimed is:

1. A map rendering method, comprising:
acquiring reference road network data comprising a plurality of reference roads and trajectory point data comprising a plurality of trajectory points;
determining, according to projection data of each of trajectory point elements in a trajectory point neighborhood set of each of the plurality of trajectory points onto at least one of the plurality of reference roads, a target road of the each of the plurality of trajectory points, respectively; and
performing map rendering according to the target road of each of the plurality of trajectory points.

2. The method according to claim 1, wherein determining, according to the projection data of the each of the trajectory point elements in the trajectory point neighborhood set of the each of the plurality of trajectory points onto the at least one of the plurality of reference roads, the target road of the each of the plurality of trajectory points, respectively, comprises:
projecting each of the plurality of trajectory points onto at least one reference road around the each of the plurality of trajectory points;
in response to determining that a trajectory point is projected onto one reference road, using the one reference road as a target road of the trajectory point; and
in response to determining that a trajectory point is projected onto at least two reference roads, determining, according to projection data of each of trajectory point elements in a trajectory point neighborhood set of the trajectory point onto at least one of the at least two reference roads, a target road of the trajectory point.

3. The method according to claim 1, wherein determining, according to the projection data of the each of the trajectory point elements in the trajectory point neighborhood set of the each of the plurality of trajectory points onto the at least one of the plurality of reference roads, the target road of the each of the plurality of trajectory points, respectively, comprises:
for each of the plurality of trajectory points, determining, according to an accumulative projection distance of the trajectory point elements in the trajectory point neighborhood set of the each of the plurality of trajectory points in each of the plurality of reference roads, the target road of the each of the plurality of trajectory points from the plurality of reference roads; and/or
for each of the plurality of trajectory points, determining, according to an accumulative number of projections of the trajectory point elements in the trajectory point neighborhood set of the each of the plurality of trajectory points in each of the plurality of reference roads, the target road of the each of the plurality of trajectory points from the plurality of reference roads.

4. The method according to claim 1, wherein the trajectory point neighborhood set of each of the plurality of trajectory points is determined in the following manner:
selecting, according to an acquisition time and a change direction of each of the plurality of trajectory points in the trajectory point data, at least two adjacent trajectory points of the each of the plurality of trajectory points from the plurality of trajectory points; and
generating the trajectory point neighborhood set comprising the each of the plurality of trajectory points and the at least two adjacent trajectory points.

5. The method according to claim 1, after acquiring the trajectory point data comprising the plurality of trajectory points and before determining, according to the projection data of each of the trajectory point elements in the trajectory point neighborhood set of each of the plurality of trajectory points onto at least one of the plurality of reference roads, the target road of the each of the plurality of trajectory points, respectively, further comprising:
in response to determining that acquisition times of two adjacent trajectory points are discontinuous, predicting at least one lost trajectory point in the two adjacent trajectory points according to the two adjacent trajectory points; and
updating the trajectory point data according to the at least one lost trajectory point.

6. The method according to claim 5, wherein predicting the at least one lost trajectory point in the two adjacent trajectory points according to the two adjacent trajectory points comprises:
determining a reference rate according to a reference time interval between the two adjacent trajectory points and a reference distance interval between the two adjacent trajectory points;
determining, according to the reference time interval and a trajectory length of each of candidate road trajectories between the two adjacent trajectory points, a candidate rate of the each of the candidate road trajectories, respectively;
selecting a target road trajectory from the candidate road trajectories according to the candidate rate and the reference rate; and
generating the at least one lost trajectory point according to the target road trajectory.

7. The method according to claim 5, wherein predicting the at least one lost trajectory point in the two adjacent trajectory points according to the two adjacent trajectory points comprises:
determining a reference rate according to a reference time interval between the two adjacent trajectory points and a reference distance interval between the two adjacent trajectory points;
determining, according to the reference rate and a trajectory length of each of candidate road trajectories between the two adjacent trajectory points, a candidate time interval of the each of the candidate road trajectories, respectively;
selecting a target road trajectory from the candidate road trajectories according to the candidate time interval and the reference time interval; and
generating the at least one lost trajectory point according to the target road trajectory.

8. The method according to claim 1, wherein performing the map rendering according to the target road of the each of the plurality of trajectory points comprises:
determining a merging sequence of target roads corresponding to the plurality of trajectory points according to an acquisition sequence of the plurality of trajectory points;
merging the target roads according to the merging sequence to generate a merged road; and
performing the map rendering according to the merged road.

9. The method according to claim 8, wherein performing the map rendering according to the merged road comprises:
determining, according to a projection point of a first trajectory point in the trajectory point data onto a target road of the first trajectory point and a projection point of a last trajectory point in the trajectory point data onto a target road of the last trajectory point, a starting point and an ending point of the merged road, respectively;
intercepting the merged road according to the starting point and the ending point; and
performing the map rendering according to the intercepted merged road.

10. An electronic device, comprising:
at least one processor; and
a memory communicatively connected to the at least one processor;
wherein the memory has instructions executable by the at least one processor stored thereon, wherein the instructions are executed by the at least one processor to cause the at least one processor to perform:
acquiring reference road network data comprising a plurality of reference roads and trajectory point data comprising a plurality of trajectory points;
determining, according to projection data of each of trajectory point elements in a trajectory point neighborhood set of each of the plurality of trajectory points onto at least one of the plurality of reference roads, a target road of the each of the plurality of trajectory points, respectively; and
performing map rendering according to the target road of each of the plurality of trajectory points.

11. The electronic device according to claim 10, wherein determining, according to the projection data of the each of the trajectory point elements in the trajectory point neighborhood set of the each of the plurality of trajectory points onto the at least one of the plurality of reference roads, the target road of the each of the plurality of trajectory points, respectively, comprises:
projecting each of the plurality of trajectory points onto at least one reference road around the each of the plurality of trajectory points;
in response to determining that a trajectory point is projected onto one reference road, using the one reference road as a target road of the trajectory point; and
in response to determining that a trajectory point is projected onto at least two reference roads, determining, according to projection data of each of trajectory point elements in a trajectory point neighborhood set of the trajectory point onto at least one of the at least two reference roads, a target road of the trajectory point.

12. The electronic device according to claim 10, wherein determining, according to the projection data of the each of the trajectory point elements in the trajectory point neighborhood set of the each of the plurality of trajectory points onto the at least one of the plurality of reference roads, the target road of the each of the plurality of trajectory points, respectively, comprises:
for each of the plurality of trajectory points, determining, according to an accumulative projection distance of the trajectory point elements in the trajectory point neighborhood set of the each of the plurality of trajectory points in each of the plurality of reference roads, the target road of the each of the plurality of trajectory points from the plurality of reference roads; and/or
for each of the plurality of trajectory points, determining, according to an accumulative number of projections of the trajectory point elements in the trajectory point neighborhood set of the each of the plurality of trajectory points in each of the plurality of reference roads, the target road of the each of the plurality of trajectory points from the plurality of reference roads.

13. The electronic device according to claim 10, wherein the trajectory point neighborhood set of each of the plurality of trajectory points is determined in the following manner:
selecting, according to an acquisition time and a change direction of each of the plurality of trajectory points in the trajectory point data, at least two adjacent trajectory points of the each of the plurality of trajectory points from the plurality of trajectory points; and
generating the trajectory point neighborhood set comprising the each of the plurality of trajectory points and the at least two adjacent trajectory points.

14. The electronic device according to claim 10, after acquiring the trajectory point data comprising the plurality of trajectory points and before determining, according to the projection data of each of the trajectory point elements in the trajectory point neighborhood set of each of the plurality of trajectory points onto at least one of the plurality of reference roads, the target road of the each of the plurality of trajectory points, respectively, further comprising:
in response to determining that acquisition times of two adjacent trajectory points are discontinuous, predicting at least one lost trajectory point in the two adjacent trajectory points according to the two adjacent trajectory points; and
updating the trajectory point data according to the at least one lost trajectory point.

15. The electronic device according to claim 14, wherein predicting the at least one lost trajectory point in the two adjacent trajectory points according to the two adjacent trajectory points comprises:
determining a reference rate according to a reference time interval between the two adjacent trajectory points and a reference distance interval between the two adjacent trajectory points;
determining, according to the reference time interval and a trajectory length of each of candidate road trajectories between the two adjacent trajectory points, a candidate rate of the each of the candidate road trajectories, respectively;
selecting a target road trajectory from the candidate road trajectories according to the candidate rate and the reference rate; and
generating the at least one lost trajectory point according to the target road trajectory.

16. The electronic device according to claim 14, wherein predicting the at least one lost trajectory point in the two adjacent trajectory points according to the two adjacent trajectory points comprises:
determining a reference rate according to a reference time interval between the two adjacent trajectory points and a reference distance interval between the two adjacent trajectory points;
determining, according to the reference rate and a trajectory length of each of candidate road trajectories between the two adjacent trajectory points, a candidate time interval of the each of the candidate road trajectories, respectively;
selecting a target road trajectory from the candidate road trajectories according to the candidate time interval and the reference time interval; and
generating the at least one lost trajectory point according to the target road trajectory.

17. The electronic device according to claim 10, wherein performing the map rendering according to the target road of the each of the plurality of trajectory points comprises:
determining a merging sequence of target roads corresponding to the plurality of trajectory points according to an acquisition sequence of the plurality of trajectory points;
merging the target roads according to the merging sequence to generate a merged road; and
performing the map rendering according to the merged road.

18. The electronic device according to claim 17, wherein performing the map rendering according to the merged road comprises:
determining, according to a projection point of a first trajectory point in the trajectory point data onto a target road of the first trajectory point and a projection point of a last trajectory point in the trajectory point data onto a target road of the last trajectory point, a starting point and an ending point of the merged road, respectively;
intercepting the merged road according to the starting point and the ending point; and
performing the map rendering according to the intercepted merged road.

19. A non-transitory computer-readable storage medium having computer instructions stored thereon, wherein the computer instructions are configured to cause a computer to perform the map rendering method according to claim 1.
